(19) United States
(12) Patent Application Publication
(10) Pub. No.: US 2007/0028299 A1
(43) Pub. Date: Feb. 1, 2007

(54) CLIENT-BASED METHOD, SYSTEM AND PROGRAM TO MANAGE MULTIPLE AUTHENTICATION

(76) Inventor: GHERARDO ALBANO, Roma (IT)

Correspondence Address: IBM CORPORATION;INTELLECTUAL PROPERTY LAW, 11400 BURNET ROAD, AUSTIN, TX, 78758, US

(21) Appl. No.: 11/459,989

(22) Filed: Jul. 26, 2006

(30) Foreign Application Priority Data
Jul. 26, 2005 (EP) 05106881.5

(51) Int. Cl. H04L 9/32

(52) U.S. Cl. 726/5

(57) ABSTRACT

A method, system and program for managing authentication with security on multiple applications are here disclosed. According to the method the user provides a master password which is never stored and which can be unique for all the applications. The Application passwords are computed the first time from the master password and, optionally, from an Application password syntax rule. The Application passwords are re-computed for each new request for authentication and never stored in the system. At first generation of the Application password at least one random key is generated. The only information stored for re-computation of the Application password is the Application name, the generated random keys and the Application password syntax rule. The Application password computation function can be changed according to the level of security and the Application syntax rule can be changed to follow the requirements of the Application.

### CROSS-REFERENCE TO RELATED APPLICATIONS

This application claims the benefit of priority of European Patent Application No. EP05106881.5 filed on Jul. 26, 2005, and entitled “A CLIENT-BASED METHOD, SYSTEM AND PROGRAM TO MANAGE MULTIPLE AUTHENTICATION” hereby incorporated by reference herein for all purposes.

### BACKGROUND

1. Technical Field

Embodiments of the present invention relate generally to computer-aided authentication methods; more particularly, embodiments of the present invention can be used when a user has the authority to access multiple systems.

2. Description of Related Art

Currently users face the need to maintain multiple userid and passwords to be authenticated in different systems/applications belonging to the user's company or external systems (typically Internet applications/websites). In order to keep a high level of security, users should normally adopt a different password for each application/system. However, people have too many userids and passwords to manage so they share passwords between applications/sites and/or write them in plain text on agendas or text files. Consequently, security is compromised even for highly important and well-protected applications. There are several systems used to mitigate the problem like those using “single sign-on” (SSO) software stacks (credentials, 3rd party authentication, or the like) or password synchronization. The problem is that all those systems can manage only known applications, i.e. applications/systems that can be integrated with the SSO/password synchronization solution and it has to be a centralized complex effort. Therefore, a user faces in any case the need to manage multiple passwords.

One conventional system attempts to solve the problem of multiple passwords by the use of a master password. Although each remote server is accessed using a different password, the user only needs to remember one master password. Unfortunately, with the solution of this patent, the passwords and userids are stored in a database and even if they are encrypted, the entire authentication system can be breached if a hacker succeeds to violate the database.

There is thus a need for providing a system and method for authenticating a user on multiple systems whilst avoiding the user to remember too many passwords and maintaining a high level of security by avoiding storing of directly usable sensitive information.

### BRIEF SUMMARY

A method, system and program for managing authentication with security on multiple applications are provided. According to one embodiment, a method for managing user authentication on a computer to access an application or a system is provided, the method comprising: receiving, at the computer, an application name and at least one preferred password, wherein the at least one preferred password comprises a master password; generating at least one random key; storing the application name and the at least one random key in a record of a storage element; using a predetermined algorithm for computing an application password using the master password and the at least one random key; and providing the application password to a user.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways including implementation in hardware, software, or a combination thereof, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

It is believed that the above features, advantages and purposes of embodiment of the present invention will be better understood from the following description of illustrative embodiments of the present invention taken in conjunction with the accompany drawings, in which:

FIG. 1 describes the environment of one embodiment of the present invention;

FIG. 2 is the general flow chart of the method according to an embodiment of the present invention;

FIG. 3 shows an example of Key table storing keys randomly generated by the method and other information related to an Application password generation according to an embodiment of the present invention;

FIG. 4 illustrates the dialog for re-computing the Application password which is part of the user interface developed according to an embodiment of the present invention;

FIG. 5 illustrates the dialog for new Application password generation which is part of the user interface developed according to an embodiment of the present invention;

FIG. 6 is the detailed flow chart for Application password generation as shown at process block 275 of the general flowchart of FIG. 2 according to an embodiment of the present invention; and

FIG. 7 describes the environment of an embodiment of the present invention with the Authentication program being implemented as a service.

The use of the same or similar reference symbols within the accompanying drawings is intended to indicate similar or identical items.

### DETAILED DESCRIPTION

With the one or more authentication method embodiments of the present invention, a user can manage easily and securely the multitude of authentication operations without compromising overall security. When passwords are first computed from user inputs (including one or more master passwords) one or more random keys are generated and stored. The computed passwords can then be used for connecting to applications but they are NOT stored. Instead, they are regenerated using the random keys that are stored; a hacker reading the content of the table storing the keys cannot regenerate the corresponding passwords without having knowledge of the master password and the computing algorithm used. Changing a password to respect expiration policies is simply managed by re-generating new random keys and computing the new password.

The same master password can be used as user input for computing passwords to connect to more than one application without jeopardizing security. This simplifies the obligation of the user who has to remember just one password.

The other advantage of the solution is related to its adaptability to different situations. For instance, more than one master password could be used to further enhance security: one master password for the company Intranet, one for Internet applications. Another alternative consists in using more than one master password for connection to one very sensitive application.

Another adaptation may also consist, for lower security grade solutions, providing a shared server which would enable the authentication service from around the world by sending the stored keys to users requesting them. This implies that there would be no need for the user to store anything locally, they could just temporarily load what is needed.

Additional adaptations of the solution are possible because it is always possible to use a different function in password computation for each remote system. It is noted also that method embodiments of the present invention can be used for locking the access of a user to an application or the login to a system from a specific computer aided device (user device). In such embodiments the password computation may depend on the Key table located on the specific user device where the access is requested. For further security, one can consider storing the Key table on a non-removable storage of the machine. Since the user can not possibly know what the final application password will be, he cannot access or be forced to access the application/system if he is not using that specific user devise. This solution is improved as compared to existing solutions in which an authorized machine, identified by its network address, is selected from the system/application or comparable solutions. This latter solution is usually network protocol-dependent and less secure because the address of the user device can possibly be fooled. Also, maintaining the user device addresses requires heavy maintenance process which is totally unnecessary with the solution embodiments of the present invention.

Furthermore, solution embodiments of the present invention are simple to install as they may be implemented as a client-based only solution. One noted advantage of such embodiments is that in a real life situation a user could benefit concurrently in the same authentication program by having different options from all the different possible implementation variations for handling authentication requests. Such options may include, for example, a user-activated solution, using published interfaces when the application activates automatically the authentication program, and/or use of specific Application authentication protocol integration where the authentication program knows the application's authentication protocol.

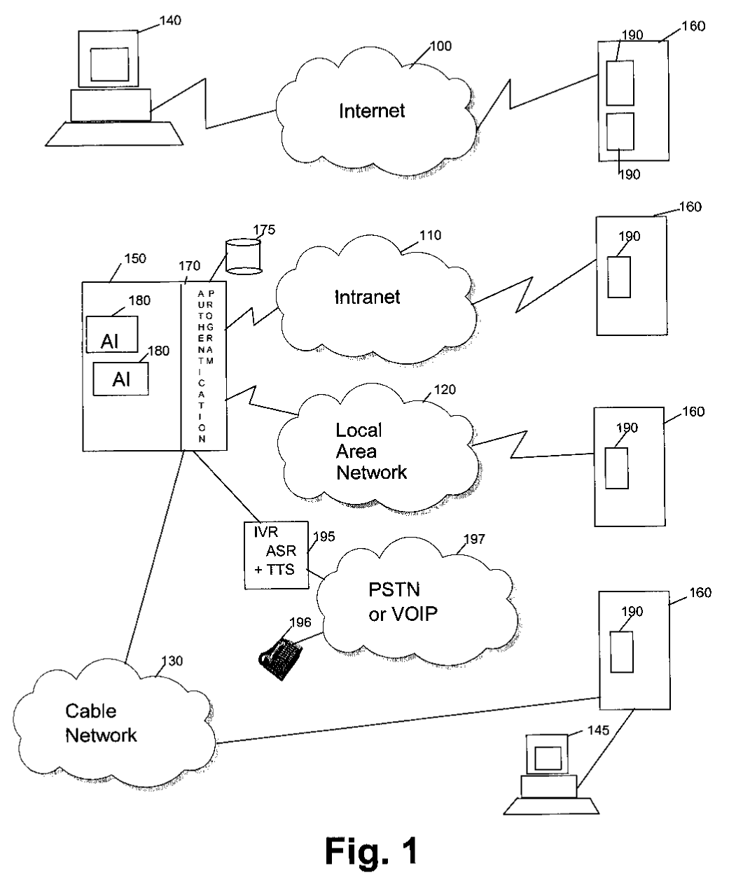

FIG. 1 describes the environment of an embodiment of the present invention. In the illustrated embodiment, an Authentication program (170) which uses particularly a Key table (175) is executed on a computer aided device (140, 145, 150) to control the access of the user to a computer system or to an application. For the rest of the document, the method of the illustrated embodiment talks about access to a so called Application which is an application but one understands the same method applies for accessing a system. The Applications (190) operate on data processing systems (160), with each Application (190) possibly providing an Application interface (180). It is noted that the Application interface can also be provided directly by the server (160). The computer aided devices can be of any type such as embedded interfaces like a smart card reader or workstations (140, 150, 145) or a voice system (195+197+196) which can be VoIP and POTS such as PSTN. The Application data processing systems may be distributed over a network (100, 110, 120, 130, 197) of any nature: local (130, 120), Wide (100, 110), wireless or wired, VoIP or PSTN (197) etc. The devices implementing the Authentication program of the invention may be remote (140, 150) or local to the application systems (145) or even resident on the same system.

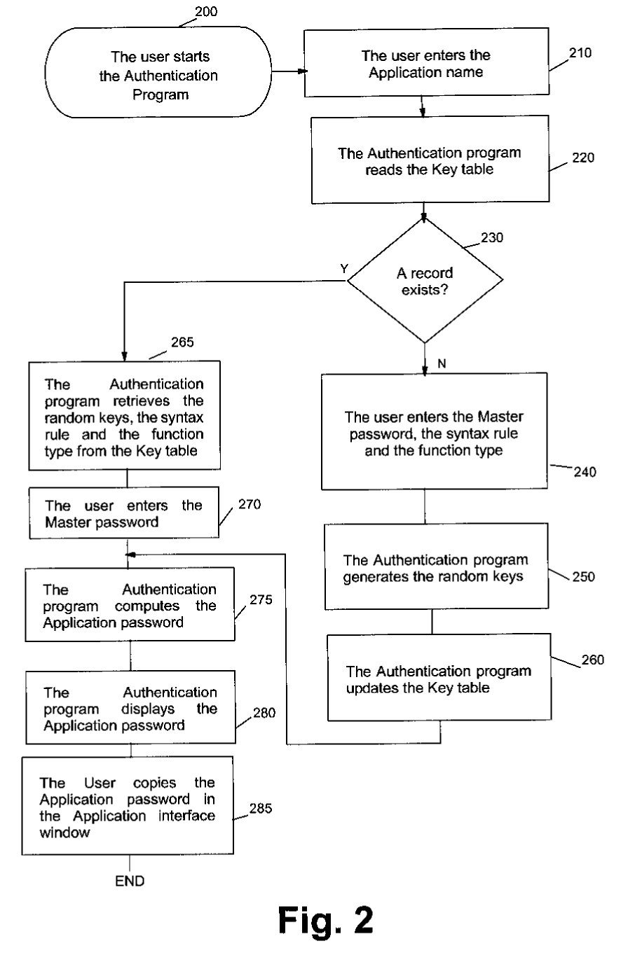

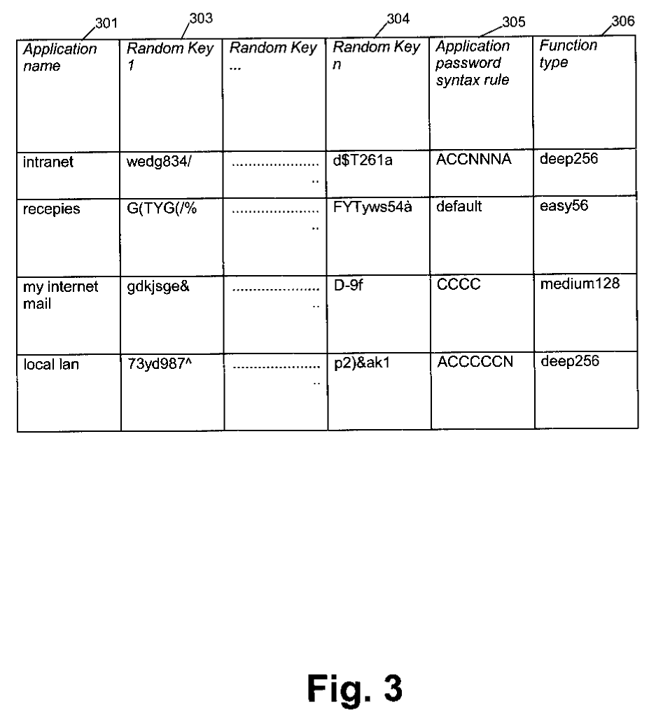

FIG. 2 is the general flow chart of the method according to an embodiment of the present invention. When a user of a device needs to connect to an Application either local or remote, he typically starts the appropriate Application interface (180). The Application interface may be a browser, a telnet session, a terminal emulation, a window-based interface or any other interfacing program. The user sends a request for a service to an Application through the Application interface. The Application usually, before satisfying the user service request, sends an authentication request to the user through the Application Interface. To satisfy the request, the user has to enter the so called userid and Application password through the Application interface. The user, in the illustrated embodiment, then starts an authentication program (200) which is an application local to the user. The authentication program is in charge to compute for the user the Application password which will be accepted by the Application. The Authentication program asks the user to enter the Application name (210). The Authentication program searches (220) if there is any record in a table, the Key table (175 and FIG. 3), containing the Application name in a specific field.

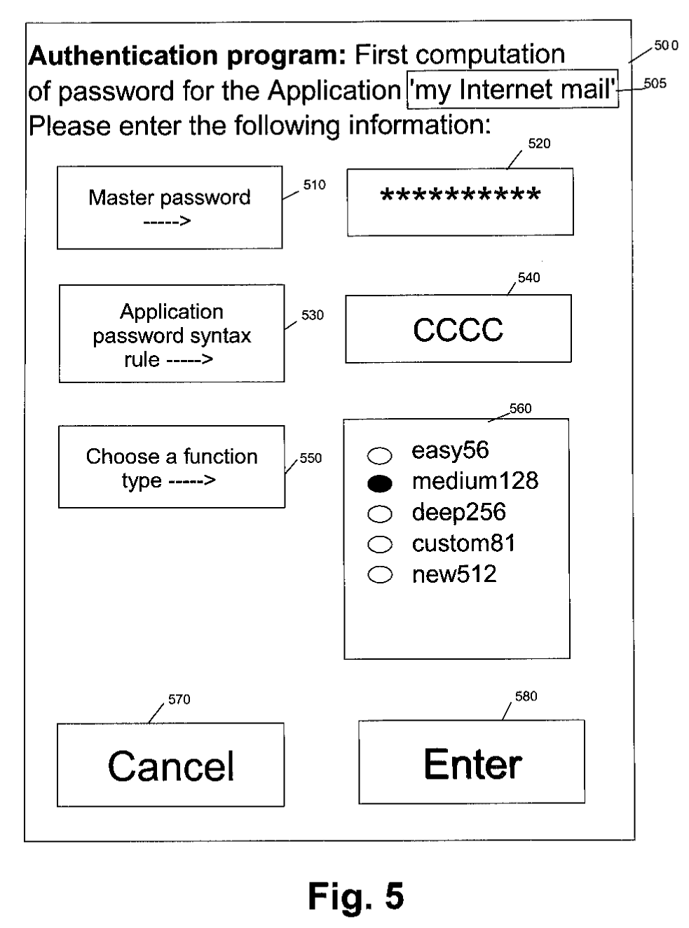

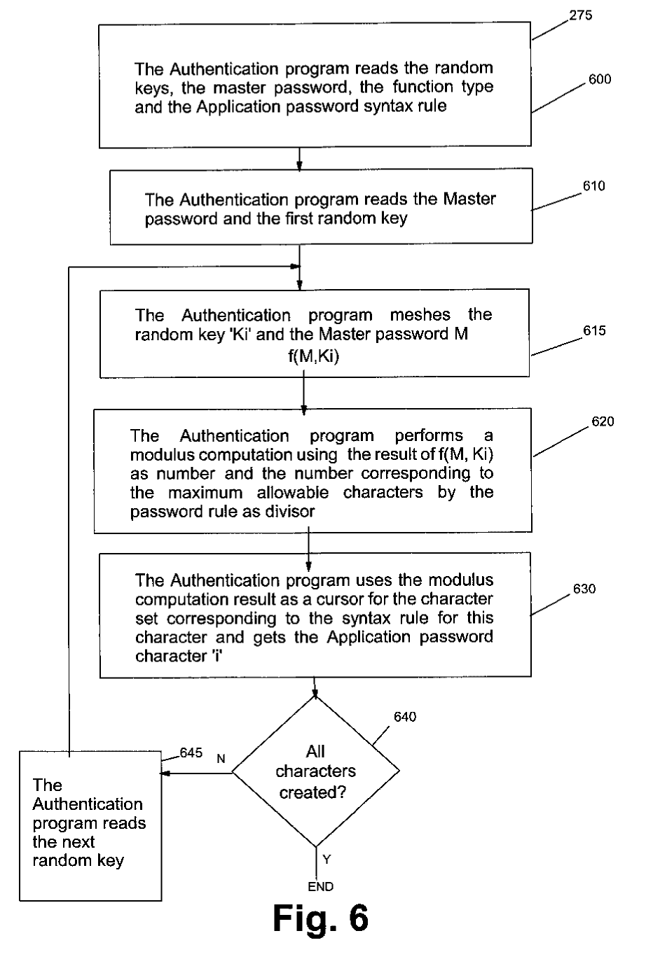

If the Authentication program does not find any record in the Key table (answer No to test 230) with the Application name provided by the user, this means that the user has never been connected to this application and that a password has to be created for the first connection of the user to this Application. In this case, the Authentication program prompts the user with a window (described later in the document in relation with FIG. 5) for first Application password computation to enter (240) a preferred password, the Master password, the ‘function type’ and the password syntax rule of the Application. The function type is an identifier which may be a mnemonic name of a mathematical function used in the computation of the Application password by the Authentication program as explained later on in the document; it may correspond to a predetermined function in the authentication program or, the user may be invited to enter mathematical function. A default value is provided for both the function type and the syntax rule if no input function is entered by the user. In the illustrated embodiment, a list of function types is displayed and the user chooses among them. Then, the Authentication program randomly generates (250) at least one key, in the illustrated embodiment one key is generated for each character of the Application password. Once the random keys are generated, the Authentication program creates a record (260) in the Key table with a field for the Application name (this field will be used as a search key for the future use of the Key table), fields for the function type, the random keys and for the Application password syntax rule. Then, the Authentication program uses the Master password, the Application password syntax rule and the random keys to compute the Application password (275). There are many existing ways to compute a password according to a syntax rule and based on keys, one exemplary embodiment is described later herein in relation with FIG. 6. In the illustrated embodiment, the Application password is displayed (280) by the Authentication program to the user in a hidden form (‘********’) once computed.

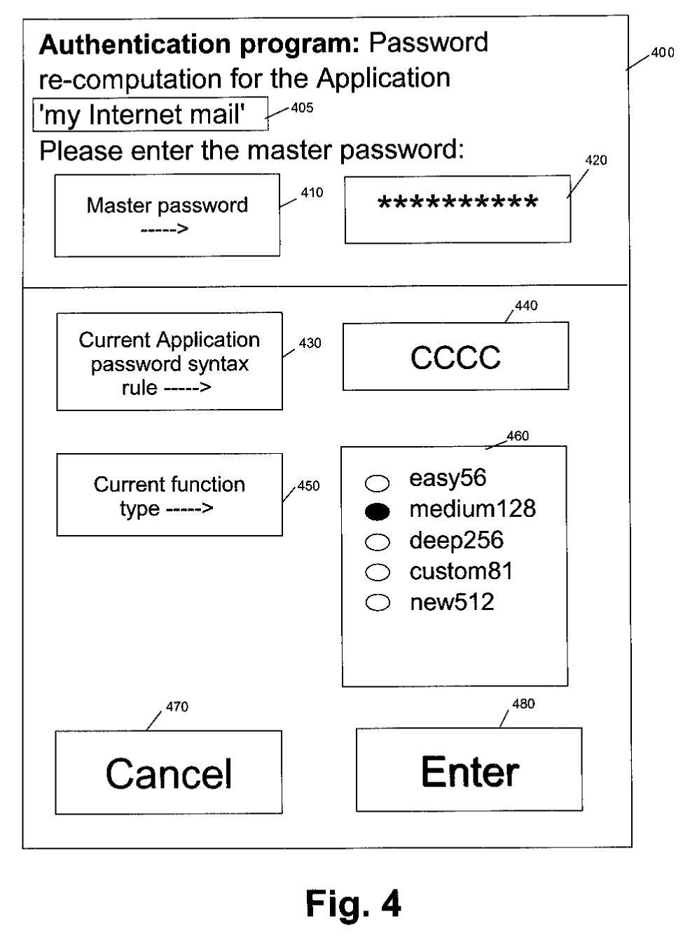

If the authentication program finds in the Key table a record with the Application name entered by the user (answer Yes to test 230), this means that the user has already accessed once the Application and that an Application password has been computed previously as just described before in the document. Consequently, the random keys have been already generated by the authentication program and stored in a record of the Key table. In this case, the authentication program, instead of displaying the window for first Application password computation, prompts the user in a window (described later in the document in relation with FIG. 4) for re-computing the Application password. The Authentication program retrieves (265) the function type, the random keys and the Application password syntax rule from the record of the Key table for this Application. Then, the user is required to enter the Master password (270) and the Authentication program computes the Application password (275) in the same way as described with the first Application password computation and displays it (280) to the user in a hidden form (‘********’) as in the illustrated embodiment.

The user reads the computed password provided by the authentication program and enters it in the Application Interface. In the illustrated embodiment, the user copies the hidden form of the Application password displayed on the window of the Authentication program and pastes it in the window of the Application interface (285). The Application password is then sent by the user to the Application through the Application interface. Then, the Application performs the password checking on the server executing the Application and starts through the Application interface a connection with the user which is now authentified. The user can now stop the Authentication program execution.

Generation of random keys: there are many existing random key generators known by the person skilled in the art. The only constraint is that these keys must be written in a record of the Key table. In the illustrated embodiment the number of generated random keys is equal to the number of characters in the Application password.

Computation of the Application password: the computation of the Application password using the random keys is performed in the illustrated embodiment character per character. In the illustrated embodiment one random key has been generated for each character of the Application password and all the keys are stored in the record of the corresponding Application in the Key table. For each character ‘i’ (‘i’ between 1 and the number of characters in the Application password) of the Application password, a first step of the computation consists in mathematically meshing a value computed from the random key ‘i’ with a value computed from the Master password using the function type chosen by the user. The function is in the form of f(M, Kᵢ) wherein M is a positive number calculated in a predetermined way from the ASCII value of each character of the Master password and Kᵢ is a positive number calculated in a predetermined way from the ASCII value of each character of corresponding random key. In the illustrated embodiment, a second step for computing a character ‘i’ of the Application password consists in converting the number computed in the first step into a character in conformance with the password syntax rule for that Application as described in FIG. 6 by using the modulus calculation technique. As stated previously, with the solution of the illustrated embodiment, the local user device only stores random keys which, if are stolen by a hacker, are not sufficient to compute the Application password as the algorithm for computing and the Master password are needed.

Number of random keys: during the computing of the Application password, there may be one or more random keys generated by the authentication program. A same and unique random key can be used in all the loops for computing the Application password characters. Alternatively, and this is the case in the illustrated embodiment, instead of generating a unique random key for computing the whole Application password, the authentication program, computes one random key for each character of the Application password. Increasing the number of random keys increases security. In other embodiments different number of keys can be generated and used for the computation of the Application password.

Number of Master passwords: the user can use the same Master password for authentication on all the Applications. Even with a same Master password for all the Applications, as the Application passwords are computed with the use of keys which are randomly generated for each Application and as the Application password syntax rules may be different, the computed Application passwords are all different. Alternatively, the user can choose to use a limited number of Master passwords according to the level of security of the different types of applications. This possibility makes the solution of the illustrated embodiment flexible and adaptable concurrently in many environments with very different levels of security.

Application syntax rules optional field: the Application password syntax rule is entered by the user in the window of the Authentication program the first time the Application password is computed. The Authentication program then stores the Application password syntax rules in the Key table and will reuse it each time the Application password is re-computed. If not defined by the user, the Authentication program will apply a default Application password syntax rule.

Function type optional field: The function type is a mnemonic name of a mathematical function used in the computation of the Application password. In the illustrated embodiment the function is used in the first step of Application password character computation. Depending on the complexity of this function the Application password computation will have different levels of security. However, the more the mathematical functions are complex the more the computation uses CPU time. Many mathematical functions can be used for that purpose and the authentication program can be parameterized accordingly. In the illustrated embodiment, the function type is chosen from a list in the window of the Authentication program for first Application password computation. If not defined by the user, the Authentication program will apply a default Application password syntax rule.

Usually, to handle an application password change requested by an Application program, the user needs both the old and new password. The user will start the Authentication program that will ask the user the same information as in FIG. 4 for the old password computation and the information as in FIG. 5 for the new password computation. Then, the authentication program re-computes the old password and computes the new password. Finally, the Authentication program displays both the old and new application passwords to the user, in a hidden form (‘********’) in the illustrated embodiment.

The user reads the computed passwords provided by the authentication program and enters it in the Application Interface. In the illustrated embodiment, the user copies the hidden form of the Application passwords displayed on the window of the Authentication program and pastes them in the window of the Application interface. As the password change is confirmed to the user by the Application program and by the user to the Authentication program, the new information are stored in the record of the Key table.

Other embodiments may have the following variations that can possibly be combined:

Remote Key table: localizing the Key table remotely from the Application interface instead of locally. In this case the Key table could also be used by more than one user and each record then will include an additional field for the ‘userid’. When the user uses the Authentication program he must also provide the userid. A centralized and common table is valuable to provide a centralized service with userid and application name combination as the unique key to distinguish the records.

Never-ending Authentication program: implementing the Authentication program as an autostart never-ending program still running locally on the user device, that intercepts the authentication request from the Application and display to the user the Authentication program interface providing the Application name to the user, then behaves as usual and sends the computed password directly to the requesting application. This is not the illustrated embodiment as, in this case the authentication program is adapted to the specific protocol of the Application in relation with authentication. The Authentication program in this embodiment cannot be a program independent from any Application the user intends to connect to from his user device. This negative effect could be mitigated by contingent situations like when many applications do conform to the same standard for the authentication.

Authentication program as published interface: implementing the Authentication program as a published interface with a resident program lava applet, ActiveX . . . ) or a remote service (web services . . . ) that is beeing invoked by the authentication system. The Application uses the Authentication Program published interfaces to send to it the application name. The Authentication program then interfaces the user providing the Application name and gets the missing data (master password . . . ). Then computes the application password and using the published interfaces sends back the computed password directly to the requesting Application. As with the never ending Authentication program, this is not the illustrated embodiment as, in this case the application is adapted to the specific published interfaces of the Authentication program in relation with authentication. The Application program cannot be independent from the Authentication program that the user uses. This negative effect could be mitigated is the published interfaces of the Authentication program could be standardized.

FIG. 3 shows an example of Key table according to an embodiment of the present invention. The key table stores the only permanent information needed by the Authentication program. The first field contains the Application name (301), the following fields contain the random keys (303 . . . 304) and the last field contains the Application password syntax rule (305). In 305, “A” means to store alphabetic and numeric characters describing the password syntax rule: N for any number, C for any character. Other codings can be used to express the password rules.

If the Authentication program offers the possibility of having a possible choice other than the by the default value for the function type, a field (306) contains also the function type designated by the user. It is an option not to store the function type to enhance security. In this case the user will provide the information each time the authentication is needed. The Application name, Application password syntax rule and the function type are entered by the user and stored by the Authentication program at first time computation of the Application password. The random keys are computed and stored in the Key table at the first time computation of the Application password by the Authentication program.

FIG. 4 illustrates the window (400) of the Authentication program user dialog for re-computing the Application password according to the illustrated embodiment. In this example, the user has previously entered the Application name, here, ‘my Internet mail’ (405). In this window the Authentication program displays an information box (410) for collecting the master password, that is needed to re-compute the Application password of an Application already known, in the corresponding field (420) wherein the Master password is displayed in an hidden form (‘********’). The Authentication program also provides to the user the information for the password syntax rule (430) and function type (450) retrieved from the Key table in the fields (440, 460). One button (470) is clicked by the user to close the interface without providing the information and a second button (480) is clicked by the user to submit the information to the Authentication program for the Application password re-computation.

FIG. 5 illustrates the window (500) of the Authentication program user dialog for computing for the first time the Application password according to an embodiment of the present invention and updating the Key table. In this example, the user has entered the Application name, here, ‘my Internet mail’ (505). In this window the Authentication program displays other information boxes for collecting all the information needed to compute the Application password for the first time. A first information box (510) is for the user to enter the Master password in the corresponding field (520) wherein the Master password is displayed in an hidden form (‘********’). One other information box (530) is for the user to enter the Application password syntax rule in the corresponding field (540). One other information box (550) is for the user to enter a function type by choosing one of the lists in the corresponding field (560). The function type is the function which will be used by the Authentication program of the illustrated embodiment to mathematically mesh the Master password with the random keys in the first step for Application password generation. The list of function type is in the order of complexity which implies more security and more CPU time at execution. One button (570) is used by the user to close the interface without providing the information and a second button (580) is used by the user to submit the information to the Authentication program for Application password first computation and storing of the information (505, 540, 560) with the random keys in a new record of the Key table as described in FIG. 3.

FIG. 6 is the flowchart of the Application password generation operation indicated by process block 275 in the general flowchart of FIG. 2. The first operation (process block 600) consists for the Authentication program to read the information which will be used for Application password generation. In the case where this Application password generation is a re-computation, the Authentication program reads the random keys, the function type and the Application password syntax rule in the record of the Key table corresponding to this Application. The Master password is read by the Authentication program from the inputs provided by the user in the menu as described in relation with FIG. 4. In the case where the Application password generation is a first computation, the password generator acquires the needed data by reading the inputs provided by the user in the corresponding window as described in relation with FIG. 5. The Authentication program computes the Application password character per character in the illustrated embodiment. The Authentication program reads the Master password and mathematically meshes it (615) with the first random key to obtain a first number as described previously in the patent. If the Application password syntax rule for the first character has to be an alphabet character, as an example, the Authentication program takes the modulus 26 of this number (620) and uses it as a cursor to find the corresponding letter (630) of the alphabet (A for 0, B for 1 . . . ). This letter is thus the first character of the Application password. Similarly a modulus 10 computation (620, 630) would had been performed if the syntax rule for the character would had been a single digit integer, on the number resulting from the meshing operation as well known in the art. In general, the Authentication program performs a modulus computation using the result of f(M, Ki) as number and the number corresponding to the maximum allowable characters by the password rule as divisor. If all the characters are not created (answer ‘No’ to test 640), the next random key is read (645) and the process (615, 620, 630) is repeated until all the characters of the Application password are computed (answer yes to test 640).

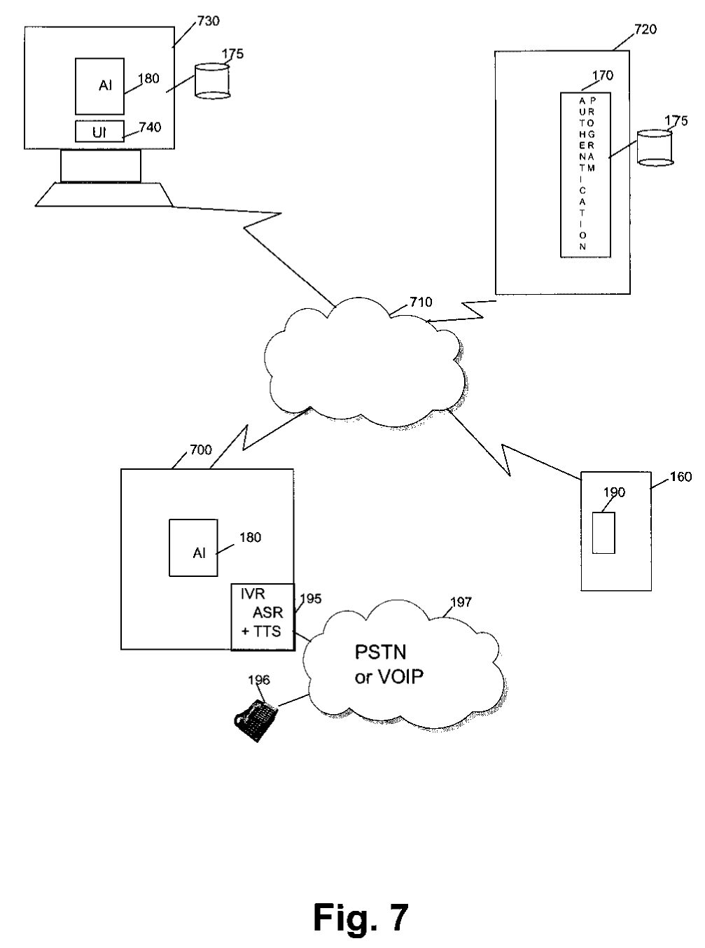

FIG. 7 describes an embodiment of the present invention where the Authentication program is provided as a service to a user who wants to connect to a given Application. The user may be, of all the types described in FIG. 1. It could be a user needing authentication to connect to an Application (190) on a remote server (160) through a network (710) from a user device (730) or a user needing to connect to an Application through a telephone line (196, 197) and a relay server (700) operating an IVR (Interactive Voice Response) program and the Application interface. The difference is that the Authentication service (170) neither operates on the user device nor on the relay server (700) but as an independent application operating on a provider server (720) and acts as a proxy for the user. A user interface (740) allows connection of the user to the Authentication program service. The Authentication service generates and stores the Key table (175) for the user. It is noted that the Authentication program when used as a service identifies the user requesting authentication and uses his specific Key table. When the user wants the Authentication program on the provider to re-compute an Application password, the Authentication program collects the Master password and the Application name from the user, generates and sends back to the user the Application password.

Another service situation is the one that provides the user with a safe storage and delivery of the key table. In that situation the Authentication program (170) and the key table (175) would be delivered to the requesting user that would then use them as in the illustrated embodiment and its possible applicable variations. This service and the previous one could be of value also if used on an intranet with the provider server (720) and when accessible only from a secured user device (730) or relay server (700) to enforce location security.

There are different implementations with the Authentication program implemented as a service to improve usability or security. To improve usability and security, if the user device (730) is to be considered unsafe, the Authentication program on the provider server (720) instead of sending back to the user the Application password, sends the Application password directly to the corresponding Application (190) on the remote server (160) thus avoiding the need to provide it to an unsecured systems (730, 700). As with the solutions, already described sooner in the document, of Never-ending Authentication program or Authentication program as published interface, the Application program is not independent from the Authentication program.

Other implementations of the invention as a service may have an improved security. In order to avoid sending the Master password from the user device to the provider, a one time password (OTP) is added at the end of the Master password before sending it from the user interface (UI). In this implementation an OTP generator program is operated by the user and the provider. The OTP generators are well known in the art: the OTP generators pseudo randomly generate simultaneously for the user and for the provider a token, which is an eight digit number for instance. On reception of the Master password and the OTP on the provider, the Authentication program checks if the Master password really comes from the given user by checking that the OTP generated by the user and by the provider are the same. Only when the OTP are the same on the two machines the Authentication program computes the Application password from the Master password and the random keys. A hacker can intercept the Application password and the OTP but cannot use them to access the remote application because the access will take place at a different moment and the OTC will be no more valid for the Authentication program.

One other implementation of the invention as a service can comprise a split of the Key table (175) between the user device (730) and the provider server (720). The split of the Key table into two Key tables can be done by replicating the Application name on the remote and the local Key tables, the Application password syntax rule and the function type being either replicated or not on the two Key tables and a part of the random keys are stored on the local Key table and the remaining random keys being stored on the remote Key table. When the Key table is split into a remote and a local Key table, the request for authentication service sent by the UI always includes a part of the random keys read locally by the UI program on the computer device of the user. To compute the Application password, the Authentication program on the provider needs the random keys stored in the part of the Key table stored on the provider and the random keys stored on the second part of the Key table stored on the user computer device and which are sent by the user to the provider with the Master password. This would provide the benefit of implicit authentication of the user by the service provider and user control of his key table as one part would not be permanently available to the provider server (720).

It is noted also that, in the case where the Authentication program is implemented as a published interface, the spilt of the Key table similarly to the kind of split described in the previous paragraph, can be done between the user device (730), the provider (720) and the server hosting the Application (160) because the Application (190) can use this published interface to communicate with the Authentication program on the provider. This would further provide the additional benefit of implicit authentication of the user and the Application by the service provider.

What is claimed is:

1. A method for managing user authentication on a computer, said method comprising:
receiving, at the computer, an application name and at least one preferred password, wherein the at least one preferred password comprises a master password;
generating at least one random key;
storing the application name and the at least one random key in a record of a storage element;
computing an application password using a predetermined algorithm, the master password, and the at least one random key; and
providing the application password to a user.

2. The method of claim 1 wherein
said receiving further comprises,
receiving an application password syntax rule;
said storing further comprises,
storing the application password syntax rule in the record of the storage element; and
computing the application password further comprises,
computing the application password utilizing the application password syntax rule.

3. The method of claim 2 further comprising:
searching in the storage element for said record;
reading the at least one random key and the application password syntax rule from said record;
re-computing the application password using the master password, the at least one random key and the application password syntax rule; and
providing the application password to the user in response to said re-computing.

4. The method of claim 2 wherein generating at least one random key comprises
applying a random key generating function as many times as the number of characters in the application password provided by the application password syntax rule, thus obtaining as many random keys as the number of characters in the application password.

5. The method of claim 2 wherein computing the application password comprises:
meshing the at least one random key with the master password using a predetermined meshing function; and
computing each character of the application password by performing modulus computation, according to the application password syntax rule, applied on a result of said meshing.

6. The method of claim 5 further comprising:
determining the predetermined meshing function said determining comprising:
receiving data indicating a selected meshing function from the user;
storing said data indicating said selected meshing function in said record; and
reading said selected meshing function.

7. The method of claim 3 wherein said storing and reading are performed locally to the computer.

8. The method of claim 3 wherein said storing and reading are performed remotely to the computer.

9. The method of claim 3 wherein said storing and reading are performed remotely and locally by splitting the Key table by columns.

10. The method of claim 1 wherein said receiving comprises receiving said application name and at least one preferred password from said user via a user computing device through a network.

11. The method of claim 10 further comprising:
adding a locally, pseudo-randomly generated first tail key to said master password utilizing said user computing device; and
randomly generating a second tail key utilizing a remote server coupled to said network; and
sending an error message to the user in response to a determination that the first tail key differs from the second tail key.

12. The method of claim 1 further comprising:
receiving a request to change the application password from the user;
computing a new application password in response to said request to change the application password; and
providing the application password and the new application password to the user.

13. The method of claim wherein said record comprises a key table.

14. The method of claim 1 wherein
said receiving further comprises,
receiving said application name from an application, and
receiving said master password from said user; and
said method further comprises providing the application password to said application.

15. A computer-readable medium having a plurality of instructions executable by a computer embodied therein, wherein said plurality of instructions, when executed, cause said computer to perform a method for managing user authentication on a computer, said method comprising:
receiving, at the computer, an application name and at least one preferred password, wherein the at least one preferred password comprises a master password;
generating at least one random key;
storing the application name and the at least one random key in a record of a storage element;
computing an application password using a predetermined algorithm, the master password, and the at least one random key; and
providing the application password to a user.

16. A system for managing user authentication on a computer, said system comprising:
means for receiving, at the computer, an application name and at least one preferred password, wherein the at least one preferred password comprises a master password;
means for generating at least one random key;
means for storing the application name and the at least one random key in a record of a storage element;
means for computing an application password using a predetermined algorithm, the master password, and the at least one random key; and
means for providing the application password to a user.
